(19) United States
(12) Patent Application Publication
(10) Pub. No.: US 2003/0005358 A1
(43) Pub. Date: Jan. 2, 2003

(54) Decentralized, self-regulating system for automatically discovering optimal configurations in a failure-rich environment

(75) Inventors: David Michael Koelle, Marlborough, MA (US); Brian James Tarbox, Littleton, MA (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/895,231

(22) Filed: Jun. 29, 2001

(51) Int. Cl. H02H 3/05

(52) U.S. Cl. 714/20

(57) ABSTRACT

A method, system and computer program for managing a set of data by a distributed set of services is provided. The set of data is organized into a plurality of related sets of data. Management of the related set of data is assigned, by a set of services, to a service within the distributed set of services based on an optimization criteria. Responsive to a failed service within the distributed set of services, management of the related set of data managed by the failed service is transferred to another service within the distributed set of services.

### BACKGROUND OF THE INVENTION

1. Technical Field

The present invention relates to an improved data processing system. More particularly, the present invention relates to providing a decentralized, self-regulating system for automatically discovering optimal configurations in a failure rich environment.

2. Description of Related Art

Faults are inevitable in digital computer systems due to such things as the complexity of the circuits and the associated electromechanical devices. To permit system operation, even after the occurrence of a fault, the art has developed a number of fault-tolerant designs. Improved fault-tolerant digital data processing systems include redundant functional units, e.g., duplicate CPUs, memories, and peripheral controllers interconnected along a common system bus. Each of a pair of functional units responds identically to input received from the bus. In the outputs, if a pair of functional units do not agree, that pair of units is taken off-line, and another pair of functional units (a “spare”) continues to function in its place.

This problem exists in any system in which services, which have the potential to fail, are responsible for maintaining items that must always be available. Prior art solutions include redundant systems, in which multiple services are kept and if one fails, others can back up the failed service. In addition, prior art solutions such as a central managing service maintains other services and can redistribute workload as needed during optimization or failure.

However, other systems that can manage fail-over and maintain optimal configurations must do so with a central authority. There are two problems associated with existing methods. The first problem is that the use of a central authority requires duplication of knowledge such as knowing which services are managing which data. Time and resources must be spent keeping this knowledge up-to-date and resources must be spent for storing this knowledge. The second problem is that the central authority itself can fail. If such a failure does occur, then no fail-over resolution or optimum configuration can occur.

Therefore, it would be advantageous to provide a mechanism for maintaining data on individual services which ensure that knowledge about which services manage which data is always current and accurate and ensures that changes to the system happen quickly and in parallel.

### SUMMARY OF THE INVENTION

The present invention provides a method, system and computer program for managing a set of data by a distributed set of services. The set of data is organized into a plurality of related sets of data. Management of the related set of data is assigned, by a set of services, to a service within the distributed set of services based on an optimization criteria. Responsive to a failed service within the distributed set of services, management of the related set of data managed by the failed service is transferred to another service within the distributed set of services.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a distributed data processing system in which the present invention may be implemented;

FIG. 2 is a block diagram depicting a data processing system that may be implemented as a server in accordance with a preferred embodiment of the present invention;

FIG. 3 is a block diagram illustrating a data processing system in which the present invention may be implemented;

FIGS. 4A and 4B are exemplary illustrations of services managing sets of data containing a sensing mechanism for detecting the failure of a service in accordance with a preferred embodiment of the present invention;

FIGS. 5A and 5B are exemplary illustrations of services managing sets of data containing a sensing mechanism for handling sets of data more optimally when an additional service comes online in accordance with a preferred embodiment of the present invention;

FIG. 6 is an exemplary flowchart illustrating maintenance of resiliency in a failure-rich environment in accordance with a preferred embodiment of the present invention; and

FIG. 7 is an exemplary flowchart illustrating a determination of an optimal configuration in accordance with a preferred embodiment of the present invention.

### DETAILED DESCRIPTION OF THE PREFERRED EMBODIMENT

With reference now to the figures, FIG. 1 is a pictorial representation of a distributed data processing system in which the present invention may be implemented. Distributed data processing system 100 is a network of computers in which the present invention may be implemented. Distributed data processing system 100 contains a network 102, which is the medium used to provide communications links between various devices and computers connected together within distributed data processing system 100. Network 102 may include permanent connections, such as wire or fiber optic cables, or temporary connections made through telephone connections.

In the depicted example, a server 104 is connected to network 102 along with storage unit 106. In addition, clients 108, 110 and 112 also are connected to network 102. These clients 108, 110 and 112 may be, for example, personal computers or network computers. For purposes of this application, a network computer is any computer coupled to a network, which receives a program or other application from another computer coupled to the network. In the depicted example, server 104 provides data, such as boot files, operating system images, and applications to clients 108, 110 and 112. Clients 108, 110 and 112 are clients to server 104. Distributed data processing system 100 may include additional servers, clients, and other devices not shown.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, education, and other computer systems that route data and messages. Of course, distributed data processing system 100 also may be implemented as a number of different types of networks, such as, for example, an intranet, a local area network (LAN), or a wide area network (WAN). FIG. 1 is intended as an example and not as an architectural limitation for the present invention.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218 and 220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

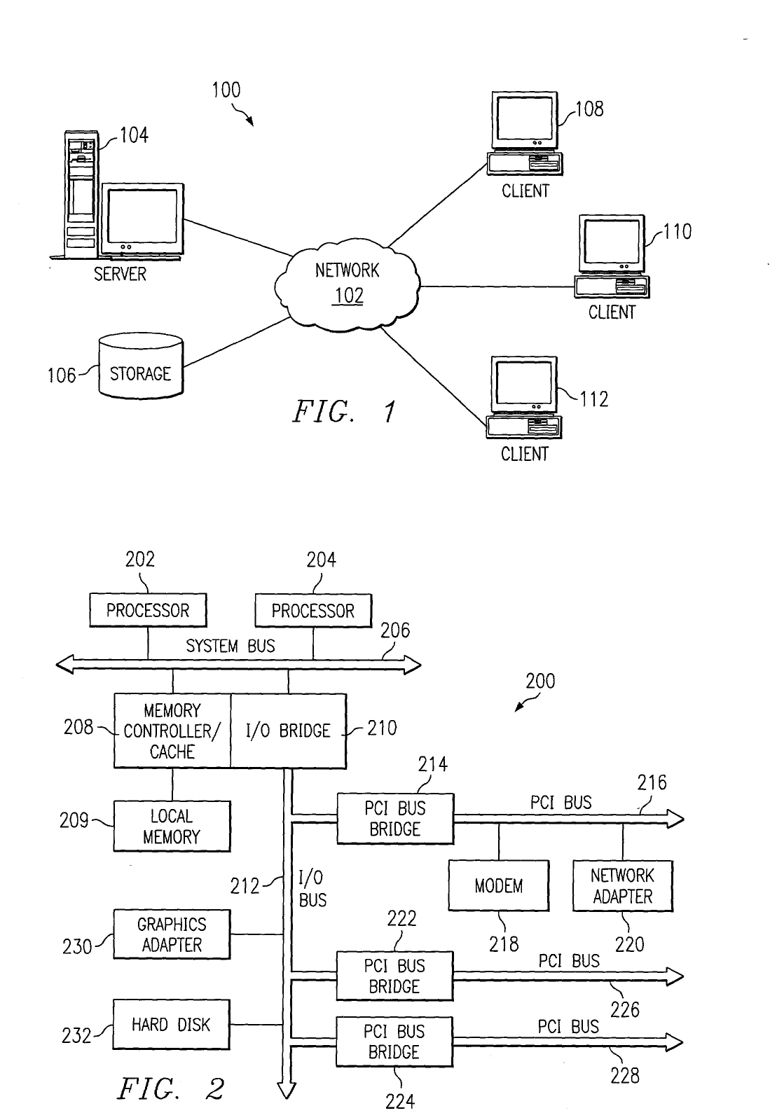

Those of ordinary skill in the art will appreciate that the hardware depicted in FIG. 2 may vary. For example, other peripheral devices, such as optical disk drive and the like also may be used in addition or in place of the hardware depicted. The depicted example is not meant to imply architectural limitations with respect to the present invention. The data processing system depicted in FIG. 2 may be, for example, an IBM eServer pSeries, a product of International Business Machines Corporation in Armonk, N.Y., running the Advanced Interactive Executive (AIX) operating system.

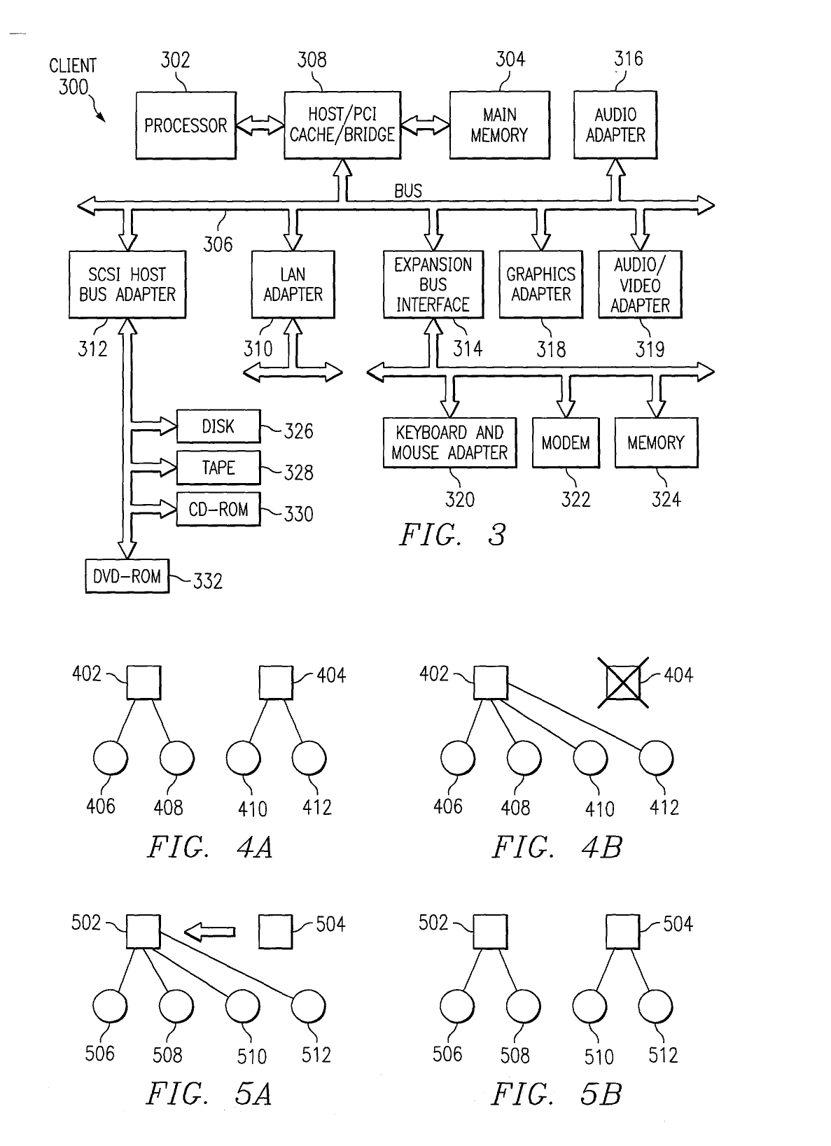

FIG. 3 is a block diagram illustrating a data processing system in which the present invention may be implemented. Data processing system 300 is an example of a client computer, such as, for example, client computers 108, 110 and 112 in FIG. 1. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations support three or four PCI expansion slots or add-in connectors.

An operating system runs on processor 302 and is used to coordinate and provide control of various components within data processing system 300 in FIG. 3. The operating system may be a commercially available operating system such as a UNIX based operating system, AIX for instance, which is available from International Business Machines Corporation. “AIX” is a trademark of International Business Machines Corporation. An object oriented programming system, such as Java, may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

For example, data processing system 300, if optionally configured as a network computer, may not include SCSI host bus adapter 312, hard disk drive 326, tape drive 328, and CD-ROM 330, as noted by dotted line 332 in FIG. 3, denoting optional inclusion. In that case, the computer, to be properly called a client computer, must include some type of network communication interface, such as LAN adapter 310, modem 322, or the like. As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device which is configured with ROM and/or flash ROM in order to provide nonvolatile memory for storing operating system files and/or user-generated data. The depicted example in FIG. 3, as well as above-described examples, are not meant to imply architectural limitations. For example, the processes of the present invention may be applied to a multiprocessor data processing system.

The present invention provides a mechanism for individual services working together in a type of “swarm” arrangement. If one service fails, the other services within the swarm may pick up the failed service's workload. By using this type of mechanism, redundancy, which is expensive and requires a multiple of every service within a system, is not required. In prior art systems, redundant systems maintain secondary systems so that if one system fails, a secondary system may back it up. However, in the present invention, other services within the swarm are already monitoring each service within the swarm, and if one of the monitoring services happens to notice that data is not being properly managed, another service will pick up the data.

The difference between the present invention and prior art systems is that in prior art systems a backup service is sitting idle. In contrast, the present invention does not need a backup service, but uses components within the system that are operating in a normal fashion, and if required to do so, these components may take on extra load if a need arises. The individual services working together also means that each individual service within the swarm knows how to optimize and deal with a failure and the service does not need to rely on a central managing mechanism.

As an example of a specific implementation, the present invention may use, for example, smart sets. Smart sets are a process which allows for grouping and managing of systems that have similar characteristics. Examples of smart sets may be operating system types and the like. The smart set architecture may be designed to be employed with, for example, a swarm of Table Cache Services (TCSs) which manage smart set groups in the TCS architecture. TCSs are a main part of a SmartSet system, the part of the SmartSet system which performs an operation. A TCS is a program that runs on any machine and performs an operation without user intervention. The TCS also responds to requests for data. The Table Cache part of the TCSs describes a specific part of a system that allows the system to store SmartSet results, which may be in a table form, and to send out the stored results when requested. Each TCS may be responsible for an arbitrary number of smart sets.

In general, TCSs may be most effective when they maintain smart sets which belong to a TCS's geopolitical location, which may be indicated by using, for example, a database and a table name. A geopolitical location is an area separated by other areas by virtue of physical forms, such as, for example, mountains, oceans, governmental boundaries, and the like. In this disclosure, a geopolitical location is used to indicate a common way in which databases are managed, for example, a “Texas” database, an “East Coast” database, and the like. By using a geopolitical location, this allows for the differentiation between, for example, routers in a first location as opposed to routers in a second location. A location corresponds to a database that serves a local network. For example, “Building 4” may be a location if “Building 4” is served by its own database.

When a new TCS comes online, the new TCS may check which existing TCSs own which existing smart sets. If the new TCS finds a SmartSet that should be, for example, in its own geopolitical location, the new TCS will ask the existing TCS owning the SmartSet for control of the SmartSet. This process allows the TCSs to maintain an optimal configuration of smart sets without the need for a centralized authority which would then dictate to each TCS which smart sets they should own.

Furthermore, if a TCS fails, the smart sets belonging to the failed TCS are released and the remaining TCSs pick up orphan smart sets which belonged to the failed TCS. If there are no TCSs specific for a SmartSet's geopolitical location, for example, then any of the remaining TCSs may pick up the orphaned SmartSet. If a more optimal TCS appears online at a later time, the new TCS may ask for the smart sets the new TCS should own and thereby providing an optimal system in addition to protection against failures within the system. In this way, the orphaned smart sets may continue to be managed. This process allows for a highly resilient behavior in a potential failure-rich environment.

The above example provides only an illustration of a specific use of the present invention. The present invention is not limited to using Table Cache Services and smart sets. The present invention may utilize any type of service and any type of data or data set. The present invention may also utilize any optimization criteria. For example, location need not be the only determining factor when selecting optimal services for the data set. Other factors may also be considered. For example, an optimal service may be one that has access to specific software tools or manipulative capability. In addition, an optimal service may be one that has a higher level of security for sensitive data or that is programmed to save volatile data files more often. Furthermore, an optimal service may be capable of more calculations per unit of time for computing complex mathematical functions. In addition, an optimal service may be used for load balancing data between services.

FIGS. 4A and 4B are exemplary illustrations of services managing sets of data containing a sensing mechanism for detecting the failure of a service in accordance with a preferred embodiment of the present invention. Services often have attached data and the service may manage the attached data. A service is an application program that performs some task. Data may be organized into a set of data within a plurality of related sets of data. However, prior to the present invention, if a service fails, the data may become unmanaged and is subsequently unavailable for use. The present invention solves this problem.

In FIG. 4A, service 402 contains attached data sets 406 and 408. Likewise, service 404 contains attached data sets 410 and 412. Services 402 and 404 may be located in different locations. Data sets 406 and 408 may or may not be in a similar location as service 402. Similarly, data sets 410 and 412 may or may not be in a similar location as service 404.

In FIG. 4B, as indicated, service 404 has failed. In such a situation, data sets 410 and 412 are in an unmanaged state and may be unavailable for use. However, service 402 detects that service 404 has failed and service 402 detects the fact that data sets 410 and 412 are in an unmanaged state. Service 402 then reaches out and attaches itself to data sets 410 and 412 and takes over the management of data sets 410 and 412. Service 402 may reach out and attach itself to data sets 410 and 412 by using a database instruction service 402 to connect to data sets 410 and 412. With this process, even though service 404 has failed leaving data sets 410 and 412 unmanaged, service 402 senses this failure and attaches to unmanaged data sets 410 and 412. By attaching to data sets 410 and 412, service 402 takes over the management of data sets 410 and 412. FIGS. 4A and 4B are a simple illustration of the present invention and many more services may be used to manage many more data sets within the spirit and scope of the present invention than that illustrated in FIGS. 4A and 4B.

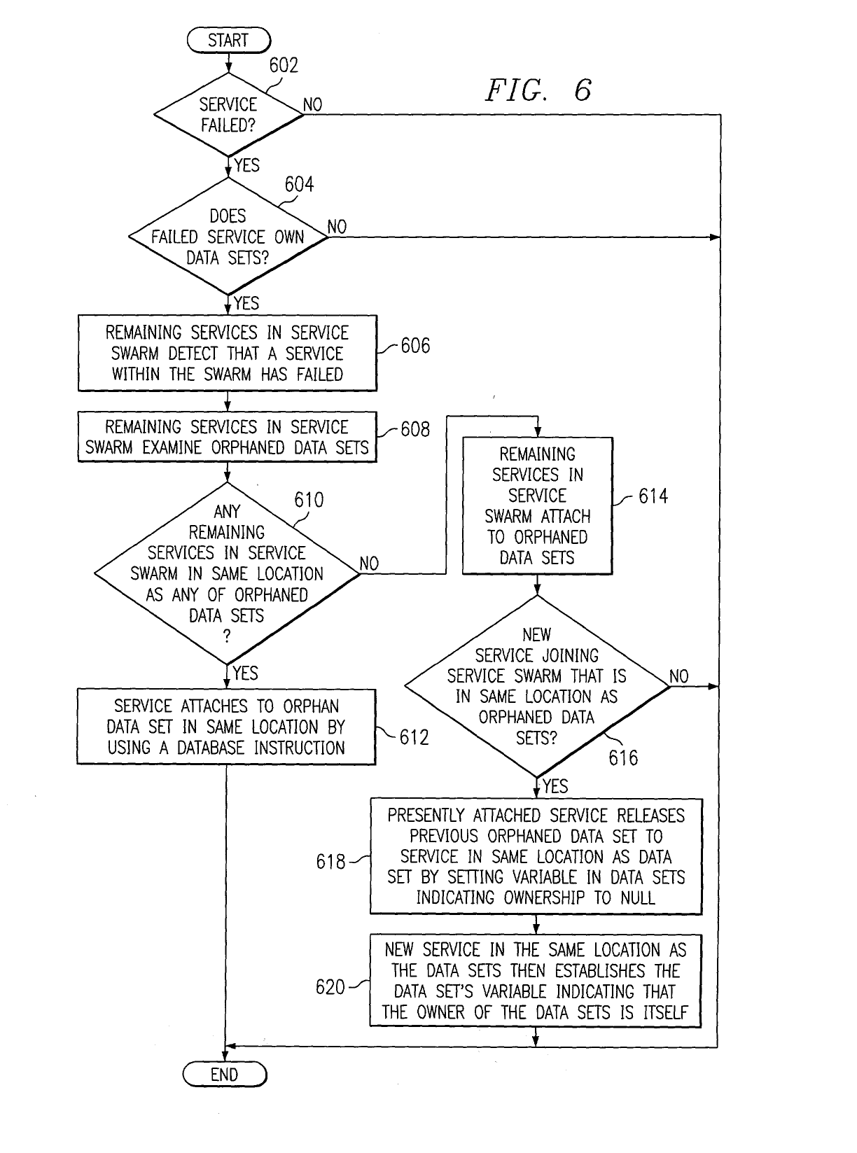

FIGS. 5A and 5B are exemplary illustrations of services managing sets of data containing a sensing mechanism for handling sets of data more optimally when an additional service comes online in accordance with a preferred embodiment of the present invention. Services within a service group allocate data between the services based on many factors. However, as stated above, a service is most efficient when the service is responsible for a data set that is included in the service's location. This effectiveness stems from the fact that transferring data within a location may not be subject to, for example, extended distances between a service and the data set, network latencies, network blockages, network outages and time consuming network routing that is often encountered in transferring data across large distances. However, prior to the present invention, if a new service joined the group of services, data within the group may not be arranged such that each service is responsible for data sets in the service's location. The present invention also solves this problem.

In FIG. 5A, service 502 contains data sets 506, 508 510 and 512. All of data sets 506, 508, 510 and 512 may be in the same location as service 502. However, one or more of data sets 506, 508, 510 and 512 may not be in the same location as service 502. When one or more of data sets 506, 508, 510 and 512 are not in the same location as service 502, the configuration of data sets 506, 508, 510 and 512 is not optimized. Optimal configuration occurs when services manage data sets that are in the same location or database. Consequences of less than optimized configurations may include, for example, delays and latency as well as the need for data retransmission if data is distorted between a source and a destination. When a new service, such as service 504, joins a group of services, then each data set 506, 508, 510 and 512 may be examined to determine the location of data sets 506, 508, 510 and 512.

In FIG. 5B, if new service 504 is in the same location as one or more of data sets 506, 508, 510 and 512, then service 504 will request that service 502 release control of one or more data sets 506, 508, 510 and 512. In this example, data sets 510, and 512 are in the same location as service 504 but not service 502. When released by service 502, data sets 510 and 512 will be attached to service 504 thereby providing optimal configuration of data sets 506, 508, 510 and 512. Attaching to a service may be as simple as the service indicating a desire to connect to a data set by using a database instruction.

FIG. 6 is an exemplary flowchart illustrating maintenance of resiliency in a failure-rich environment in accordance with a preferred embodiment of the present invention. In this example, the operation begins by a determination as to whether or not a service has failed (step 602). If a service has not failed (step 602:NO), the operation terminates. At this point, it is important to note, there may be no determination that a failed service is part of a service swarm. The service swarm has no explicit membership. The services detect unmanaged data and begin to manage the data, and when managing the data, the services may exhibit a group behavior and work together. If a service has failed (step 602:YES), then a determination is made as to whether or not the failed service owns data sets (step 604). A data set contains a variable indicating the data set's owner. If this variable is nonexistent in the data set or is set to null, the data set is unmanaged. If the failed service does not own data sets (step 604:NO), the operation terminates.

Otherwise, if the failed service does own data sets (step 604:YES), then the remaining services in the service swarm detect that a service within the service swarm has failed (step 606). Detection of a failure of a service within a service swarm may be made by use of a central directory service. Both the services and data sets have entries in the central directory service. Changes within this directory are monitored by other services, so when a change occurs in this directory, the other services can recognize these changes in the directory and thereby determine that a failure has occurred.

The remaining services in the service swarm then examine the data sets owned by the failed service which are classified as orphaned data sets (step 608). The remaining services in the service swarm examine the orphaned data sets by looking at a variable associated with the data sets which indicates the owner of the data set.

Then a determination is made as to whether or not any remaining services in the service swarm are in the same location as any of the orphaned data sets (step 610). The determination that services are in the same location as the data sets is performed by means of a variable associated with the service that indicates what location or database the service serves. Data sets also contain a variable indicating to which location the data set belongs. If the variables from a service and a data set match, then the service and the data set are in the same location. In such a case, an optimal configuration may be achieved when the service with the same location variable as the data set are connected.

If any of the remaining services in the service swarm are in the same location as any of the orphaned data sets (step 610:YES), the service in the same location as any of the orphaned data sets attaches to these data sets by using a database instruction (step 612) and thereafter the operation terminates.

If any of the remaining services in the service swarm are not in the same location as any of the orphaned data sets (step 610:NO), the remaining services in the service swarm attach to the orphaned data sets (step 614). At this point it is important to note that there is often a service in the same location as an orphaned data set, however, the most optimal service will always get a chance to connect to the data set. If a more optimal service realizes that it can improve on a connection, the more optimal service has the authority and ability to demand that a currently connected service break the connection to the data and the more optimal service can then connect itself to the data.

As an example, assume there are services containing three databases located in “Japan”, “Texas” and “California”. Each of the three databases is connected in which a transmission latency could be measured. A service in Texas ceases operation, thereby orphaning the Texas data sets. A service in Japan detects this failure of the Texas service and connects to the orphaned Texas data sets. Subsequently, a service in California also detects this failure of the Texas service and determines that the California service can handle the orphaned Texas data sets more optimally than the Japan service since the California service is closer in distance to the Texas service and may experience less latency because of this reduced distance. As the more optimal service out of the two between the Japan service and the California service, the California service asks the Japan service to disconnect from the orphaned Texas data sets, and the Japan service relinquishes control over the orphaned Texas data sets. The California service then connects to the orphaned Texas data sets. Eventually the Texas service returns to an operational mode and realizes that data sets in the Texas location are being managed by the California service. Because of the reduced distance between the Texas service and the Texas data sets, the Texas service can manage these Texas data sets more optimally than the California service. The connection between the California service and the Texas data sets is broken and the Texas service connects to the Texas data sets resulting in a more optimal configuration. The way services may attach to data sets is, for example, by indicating the data set with a database Universal Resource Location (URL), which may include the database name. If a service tries to attach to a data set in a different location than that of the service, the service may specify the location's database name in the URL. Databases are implemented using a URL. Any table in a database has a URL that refers to that database.

Then a determination is made as to whether or not a new service joining the service swarm is in the same location as any of the previously orphaned data sets (step 616). If the new service joining the service swarm is not in the same location as any of the previously orphaned data sets (step 616:NO), the operation terminates. If the new service joining the service swarm is in the same location as any of the previously orphaned data sets (step 616:YES), the service presently attached to the previously orphaned data sets releases those data sets not in the same location and the new service in the same location as the previously orphaned data sets attaches to these data sets (step 618). The service presently attached to the previously orphaned data sets releases the orphaned data sets by setting the data set's variable indicating ownership to null. The new service in the same location as the data sets then establishes the data set's variable indicating that the owner of the data sets is itself (step 620) and thereafter the operation terminates.

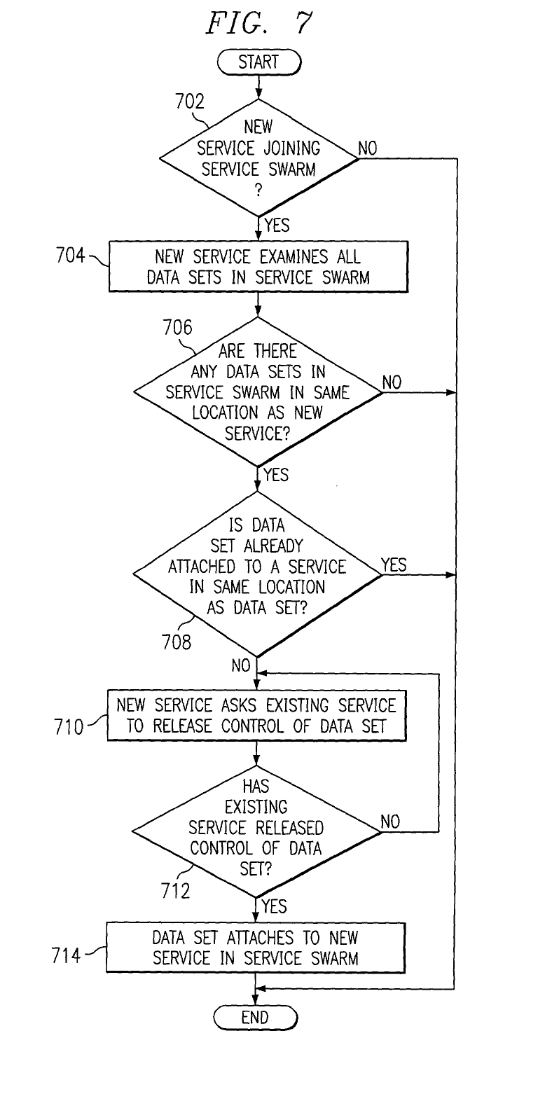

FIG. 7 is an exemplary flowchart illustrating determination of an optimal configuration in accordance with a preferred embodiment of the present invention. In this example, the operation begins by a determination as to whether or not there is a new service joining the service swarm (step 702). If there is not a new service joining the service swarm (step 702:NO), the operation terminates. If there is a new service joining the service swarm (step 702:YES), the new service examines variables associated with data sets within the service swarm to determine the data sets' location (step 704). The new service examines the data sets' ownership variables to determine which service owns the data set, the data set's location variable, and the currently connected service's location variable. Then a determination is made as to whether or not there are any data sets in the service swarm in the same location as that of the new service (step 706).

If there are no data sets in the service swarm in the same location as the new service (step 706:NO), the operation terminates. If there are data sets in the service swarm in the same location as that of the new service (step 706:YES), then a determination is made as to whether or not the data sets in the same location as the new service are currently attached to a service in the same location as the data sets (step 708). If the data sets in the same location as the new service are currently attached to a service in the same location as the data sets (step 708:YES), the operation terminates. If the data sets in the same location as the new service are not currently attached to a service in the same location as the data sets (step 708:NO), then the new service asks the existing service to release control of the data sets in the same location as the new service (step 710).

Then a determination is made as to whether or not the existing service has released control of the data sets in the same location as the new service (step 712). This determination is made by determining the existing service's location and the location of the data sets. If these two locations do not match, and the new service is a more optimal service in which to connect to the data sets, the new service will send a message to the existing service demanding the existing service release control of the data sets. When the existing service agrees to release control (disagreement is not an option because the new service has determined an optimal configuration), the existing service's variable is set to null and the new service connects to the data sets. If the existing service has not released control of the data sets in the same location as the new service (step 712:NO), then operation returns to step 710 in which the new service asks the existing service to release control of the data set. The existing service will release control of the data when asked to do so. If the existing service has released control of the data sets in the same location as the new service (step 712:YES), the data sets in the same location as the new service then attach to the new service (step 714) and thereafter the operation terminates.

Therefore, the present invention provides mechanism for maintaining data which ensure that knowledge about which services manage which data is always current and accurate and ensures that changes to the system happen quickly and in parallel. No central authority is needed. Each service within a service swarm detects the failure of an associated service within the service swarm. If such a failure occurs, then the remaining services within the service swarm analyze data sets that were attached to the failed service. If any of the data sets are in a similar location as any of the remaining services in the service swarm, then a similarly located service attaches to orphaned data sets. This mechanism provides for resiliency in a failure-rich environment. If any of the data sets are attached to a service not in a similar location as the service to which they are attached, and if a new service joins the service swarm, any data sets in the same location as the new service are released by an existing service and attach to the new service. This mechanism provides for an optimal configuration of data sets.

It is important to note that, while the present invention has been described in the context of a fully functioning data processing system, those of ordinary skill in the art will appreciate that the processes of the present invention are capable of being distributed in the form of a computer readable medium of instructions in a variety of forms, and that the present invention applies equally regardless of the particular type of signal bearing media actually used to carry out the distribution. Examples of computer readable media include recordable-type media, such as floppy discs, hard disk drives, RAM, and CD-ROMs and transmission-type media, such as digital and analog communications links.

The description of the present invention has been presented for purposes of illustration and description but is not intended to be exhaustive or limited to the invention in the form disclosed. Many modifications and variations will be apparent to those of ordinary skill in the art. For example, the present invention, while describing management of data sets based on location may also perform management of data sets based on a load balancing criteria. For example, if a local data set can be managed more efficiently by a non-local service with excess capacity versus a local service with no excess capacity, the present invention allows management of the data set by the non-local service. Furthermore, the present invention may also allow negotiation between services attempting to manage a data set. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of managing a set of data by a distributed set of services, comprising the steps of:
organizing the set of data into a plurality of related sets of data;
assigning, by a set of services, management of a related set of data to a service within the distributed set of services based on an optimization criteria; and
responsive to failure of a service within the distributed set of services, transferring management of the related set of data managed by the failed service to another service within the distributed set of services.

2. The method as recited in claim 1, wherein the optimization criteria is based on location of the service within the distributed set of services.

3. The method as recited in claim 1, further comprising:
detecting the failed service by a set of remaining services within the distributed set of services; and
examining, by the set of remaining services within the distributed set of services, the related set of data managed by the failed service.

4. The method as recited in claim 3, further comprising:
determining whether data within the related set of data are at the same location as a service within the set of remaining services; and
responsive to data within the related set of data at the same location as a service within the set of remaining services, attaching the data to the service.

5. The method as recited in claim 1, further comprising:
responsive to an additional service joining the distributed set of services, querying management of the data within the related sets of data; and
assigning management of a related set of data to the additional service within the distributed set of services based on the optimization criteria.

6. A method of managing a set of data by a distributed set of services, comprising the steps of:
organizing the set of data into a plurality of related sets of data;
assigning, by a set of services, management of a related set of data to a service within the distributed set of services based on an optimization criteria;
responsive to an additional service joining the distributed set of services, querying management of the data within the related sets of data; and
assigning management of a related set of data to the additional service within the distributed set of services based on the optimization criteria.

7. The method as recited in claim 6, wherein the optimization criteria is based on location of the service within the distributed set of services.

8. The method as recited in claim 6, further comprising:
detecting a failed service in the distributed set of services by a set of remaining services within the distributed set of services; and
examining, by the set of remaining services within the distributed set of services, the related set of data managed by the failed service.

9. The method as recited in claim 8, further comprising:
determining whether data within the related set of data are at the same location as a service within the set of remaining services; and
responsive to data within the related set of data at the same location as a service within the set of remaining services, attaching the data to the service.

10. A data processing system, comprising:
a system bus;
a memory, including a set of instructions, functionally connected to the system bus; and
a processing unit functionally connected to the system bus, wherein the processing unit executes the set of instructions from the memory to organize a set of data into a plurality of related sets of data, wherein the data in each related set of data has at least one attribute between members, the processing unit assigns, by a set of services, management of a related set of data to a service within the distributed set of services based on an optimization criteria, and, responsive to a failed service within the distributed set of services, the processing unit transfers management of the related set of data managed by the failed service to another service within the distributed set of services.

11. A data processing system, comprising:
a system bus;
a memory, including a set of instructions, functionally connected to the system bus; and
a processing unit functionally connected to the system bus, wherein the processing unit executes the set of instructions from the memory to organize a set of data into a plurality of related sets of data, wherein the data in each related set of data has at least one attribute between members, the processing unit assigns, by a set of services, management of a related set of data to a service within the distributed set of services based on an optimization criteria, responsive to an additional service joining the distributed set of services, the processing unit queries management of the data within the related sets of data, and the processing unit assigns management of a related set of data to the additional service within the distributed set of services based on the optimization criteria.

12. A data processing system for managing a set of data by a distributed set of services, comprising:
organizing means for organizing the set of data into a plurality of related sets of data, wherein the data in each related set of data has at least one attribute between members;
assigning means for assigning, by a set of services, management of a related set of data to a service within the distributed set of services based on an optimization criteria; and
transferring means, responsive to a failed service within the distributed set of services, for transferring management of the related set of data managed by the failed service to another service within the distributed set of services.

13. The data processing system as recited in claim 12, wherein the optimization criteria is based on location of the service within the distributed set of services.

14. The data processing system as recited in claim 12, further comprising:
detecting means for detecting the failed service by a set of remaining services within the distributed set of services; and
examining means for examining, by the set of remaining services within the distributed set of services, the related set of data managed by the failed service.

15. The data processing system as recited in claim 14, further comprising:
determining means for determining whether data within the related set of data are at the same location as a service within the set of remaining services; and
attaching means, responsive to data within the related set of data at the same location as a service within the set of remaining services, for attaching the data to the services.

16. The data processing system as recited in claim 12, further comprising:
querying means, responsive to an additional service joining the distributed set of services, for querying management of the data within the related sets of data; and
assigning means for assigning management of a related set of data to the additional service within the distributed set of services based on the optimization criteria.

17. A data processing system for managing a set of data by a distributed set of services, comprising:
organizing means for organizing the set of data into a plurality of related sets of data;
assigning means for assigning, by a set of services, management of a related set of data to a service within the distributed set of services based on an optimization criteria;
querying means, responsive to an additional service joining the distributed set of services, for querying management of the data within the related sets of data; and
assigning means for assigning management of a related set of data to the additional service within the distributed set of services based on the optimization criteria.

18. The data processing system as recited in claim 17, wherein the optimization criteria is based on location of the service within the distributed set of services.

19. The data processing system as recited in claim 17, further comprising:
detecting means for detecting a failed service in the distributed set of services by a set of remaining services within the distributed set of services; and
examining means for examining, by the set of remaining services within the distributed set of services, the related set of data managed by the failed service.

20. The data processing system as recited in claim 19, further comprising:
determining means for determining whether data within the related set of data are at the same location as a service within the set of remaining services; and
attaching means, responsive to data within the related set of data at the same location as a service within the set of remaining service, attaching the data to the service.

21. A computer program product in a computer readable medium for managing a set of data by a distributed set of services, comprising:
instructions for organizing the set of data into a plurality of related sets of data;
instructions for assigning, by a set of services, management of a related set of data to a service within the distributed set of services based on an optimization criteria; and
instructions, responsive to a failed service within the distributed set of services, for transferring management of the related set of data managed by the failed service to another service within the distributed set of services.

22. The computer program product as recited in claim 21, wherein the optimization criteria is based on location of the service within the distributed set of services.

23. The computer program product as recited in claim 21, further comprising:
instructions for detecting the failed service by a set of remaining service within the distributed set of services; and
instructions for examining, by the set of remaining services within the distributed set of services, the related set of data managed by the failed service.

24. The computer program product as recited in claim 23, further comprising:
instructions for determining whether data within the related set of data are at the same location as a service within the set of remaining services; and
instructions, responsive to data within the related set of data at the same location as a service within the set of remaining services, for attaching the data to the service.

25. The computer program product as recited in claim 21, further comprising:
instructions, responsive to an additional service joining the distributed set of service, for querying management of the data within the related sets of data; and
instructions for assigning management of a related set of data to the additional service within the distributed set of services based on the optimization criteria.

26. A computer program product in a computer readable medium for managing a set of data by a distributed set of services, comprising the steps of:
instructions for organizing the set of data into a plurality of related sets of data;
instructions for assigning, by a set of services, management of a related set of data to a service within the distributed set of services based on an optimization criteria;
instructions, responsive to an additional service joining the distributed set of services, for querying management of the data within the related sets of data; and
instructions for assigning management of a related set of data to the additional service within the distributed set of services based on the optimization criteria.

27. The computer program product as recited in claim 26, wherein the optimization criteria is based on location of the service within the distributed set of services.

28. The computer program product as recited in claim 26, further comprising:
instructions for detecting a failed service in the distributed set of services by a set of remaining services within the distributed set of services; and
instructions for examining, by the set of remaining services within the distributed set of services, the related set of data managed by the failed service.

29. The computer program product as recited in claim 28, further comprising:
instructions for determining whether data within the related set of data are at the same location as a service within the set of remaining services; and
instructions, responsive to data within the related set of data at the same location as a service within the set of remaining services, for attaching the data to the service.
